(19) United States
(12) Patent Application Publication
(10) Pub. No.: US 2014/0068545 A1
(43) Pub. Date: Mar. 6, 2014

(54) Managing Social Process of Developing Application

(71) Applicants: Doron Lehmann, Kfar Vradim (IL); Eyal Nathan, Tel-Aviv (IL); Nimrod Barak, Tel Aviv (IL)

(72) Inventors: Doron Lehmann, Kfar Vradim (IL); Eyal Nathan, Tel-Aviv (IL); Nimrod Barak, Tel Aviv (IL)

(73) Assignee: SAP PORTALS ISRAEL LTD, Ra'anana (IL)

(21) Appl. No.: 13/596,273

(22) Filed: Aug. 28, 2012

(51) Int. Cl. G06F 9/44

(52) U.S. Cl. 717/101

(57) ABSTRACT

A computer-implemented method for managing a social process of developing an application includes: making an integrated development environment accessible to a user; exposing a work product of the user in the integrated development environment to a selected group of users; receiving, in the integrated development environment, a first input regarding the work product from at least one of the selected group of users; and presenting the first input to the user in the integrated development environment.

### BACKGROUND

When a developer is developing an application program, or when someone is working on a task related to the development, there are several stakeholders who each has an interested in the person's work. For example, there may be a product “owner” within the company, meaning a person who is in charge of the process of developing and manufacturing the product. Other examples include, but are not limited to, user interface (UI) designers, fellow developers, architects, and end users.

Today, a developer often receives a set of requirements for the application before starting the development, and thereafter develops the application according to his or her knowledge, understanding and experience. Sometimes, the application becomes visible to the stakeholders only when the development process is finished, or at a late stage thereof.

### SUMMARY

In a first aspect, a computer-implemented method for managing a social process of developing an application includes: making an integrated development environment accessible to a user; exposing a work product of the user in the integrated development environment to a selected group of users; receiving, in the integrated development environment, a first input regarding the work product from at least one of the selected group of users; and presenting the first input to the user in the integrated development environment.

In a second aspect, a computer program product is embodied in a non-transitory computer-readable storage medium and includes instructions that when executed by a processor perform a method for managing a social process of developing an application. The method includes: making an integrated development environment accessible to a user; exposing a work product of the user in the integrated development environment to a selected group of users; receiving, in the integrated development environment, a first input regarding the work product from at least one of the selected group of users; and presenting the first input to the user in the integrated development environment.

In a third aspect, a system includes: one or more processors; and a computer program product embodied in a non-transitory computer-readable storage medium and comprising instructions that when executed cause performance of a method for managing a social process of developing an application. The method includes: making an integrated development environment accessible to a user; exposing a work product of the user in the integrated development environment to a selected group of users; receiving, in the integrated development environment, a first input regarding the work product from at least one of the selected group of users; and presenting the first input to the user in the integrated development environment.

Implementations can include any or all of the following features. Receiving the input comprises receiving a document uploaded by the at least one of the selected group of users, and wherein presenting the input to the user comprises providing the user access to the uploaded document. Exposing the work product comprises sharing material from the user, wherein receiving the input comprises receiving a change to the material from the at least one of the selected group of users, and wherein presenting the input to the user comprises tracking the change in the material. Presenting the input to the user further comprises providing the user ability to accept or reject the tracked change. Presenting the first input to the user further comprises providing the user ability to make a second input in the integrated development environment, the second input indicating at least whether the user accepts or rejects the first input. The method further includes assigning a rating to the at least one of the selected group of users based on whether the user accepts or rejects the first input. The method further includes performing at least one action in the integrated development environment regarding the at least one of the selected group of users, the action selected based on the assigned rating.

Implementations can provide any or all of the following advantages. Application development can be enhanced by a social process. Stakeholders are given an opportunity to give input earlier in the application development process, and in a collaborative way.

The details of one or more implementations are set forth in the accompanying drawings and the description below. Other features and advantages will be apparent from the description and drawings, and from the claims.

### DESCRIPTION OF DRAWINGS

FIG. 1 shows an example of a system that can be used for a social process of application development.

FIGS. 2-5 show examples of integrated development environments that facilitate a social process of application development.

FIG. 6 shows an example of a flow diagram for a social process of application development.

FIG. 7 is a block diagram of a computing system that can be used in connection with computer-implemented methods described in this document.

Like reference symbols in the various drawings indicate like elements.

### DETAILED DESCRIPTION

This document describes systems and techniques for managing a social process of application development. The social development process can be incorporated in a developer's integrated development environment (IDE) and can facilitate a collaborative exchange of drafts, revisions, edits, documents, designs or comments in the context of developing the application.

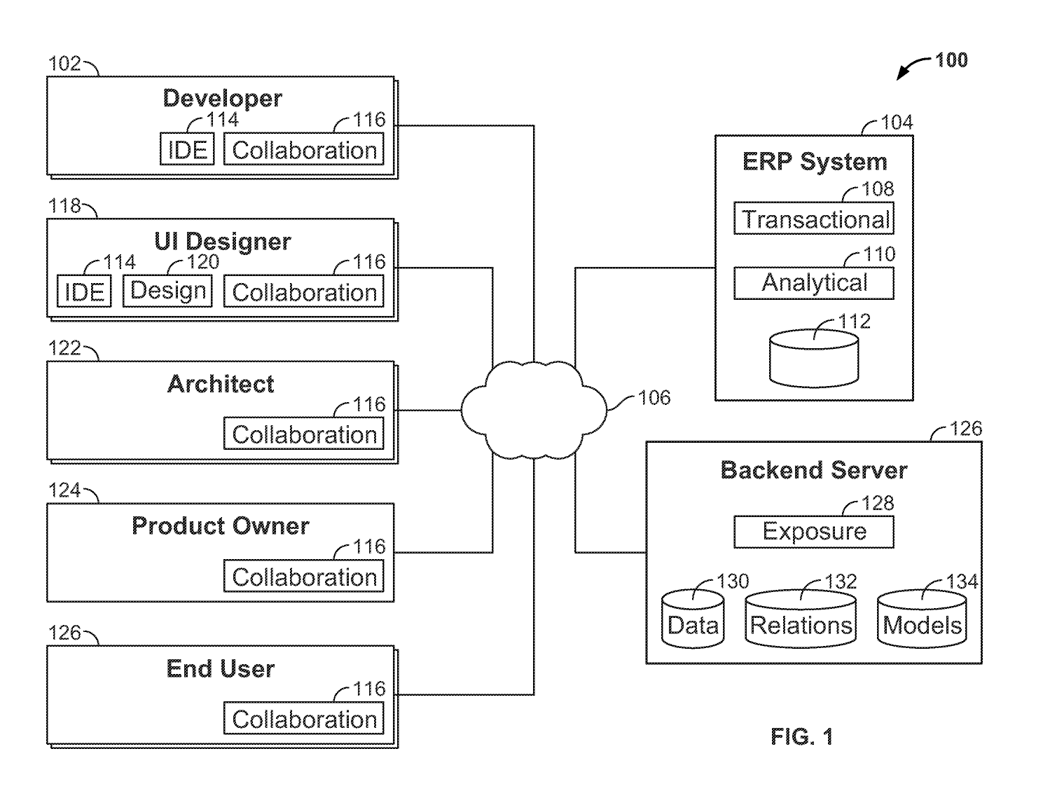

FIG. 1 shows an example of a system 100 that can be used for a social process of application development. The system 100 includes one or more developer systems 102 that are configured for developing, testing, revising and executing application code. When finished, the application code can be incorporated in one or more application programs. In some implementations, the application is being developed for use in an enterprise resource planning (ERP) system 104. For example, the developer system 102 can be connected to the ERP system, and/or to other systems, by any type of computer network 106, such as a local area network or the internet. The ERP system can include one or more components 108 for managing transactional functions, one or more components 110 for managing analytical functions, and one or more data repositories 112 (e.g., a database) for storing data and other information.

The developer system 102 includes an IDE 114. Any suitable IDE can be used, including, but not limited to, the NetWeaver Developer Studio available from SAP AG. The IDE provides the tool(s) that the developer needs for the entire process of creating the application. For example, the IDE can allow the developer to perform some or all of the following tasks:

The developer can survey objects. In some implementations, the developer can access objects that will be available for the future application. The developer can browse or otherwise search for the objects by application, by object type, and/or by development class, to name just a few examples.

The developer can generate executable code or other program content. In some implementations, the developer uses one or more tools in the IDE for this purpose. The developer can use a dictionary, an editor, a function builder, a class builder, a screen painter, and/or a menu painter, to name just a few examples.

The developer can test the application or components thereof. In some implementations, the developer uses one or more tools in the IDE for this purpose. The IDE can provide tools for runtime analysis, tracing, dump analysis, and/or code checking, to name just a few examples.

The developer can use one or more utilities in the IDE. The IDE can provide tools for document maintenance, support packages, upgrading, querying, and/or enhancements, to name just a few examples.

The developer system 102 also includes a collaboration component 116 that can be used to facilitate the social process of application development. In some implementations, the collaboration can take place in one or more directions. For example, the developer using the system 102 can receive feedback or suggestions on a current project from a colleague, and can also or instead provide feedback on another project, whether run by the same colleague or someone else.

Here, the system 100 also includes one or more UI designer systems 118. In some implementations, the system 118 is used by a person who is tasked with designing the UI for a particular application program, such as the one that the developer is currently working on. The UI designer system can include the IDE 114 and the collaboration component 116. The UI designer system can also include one or more particular design tools 120, for example a visual editor configured for generating and presenting UIs. The collaboration tool allows the UI designer to give input on the work of the developer, and/or to receive feedback on a UI design from the developer or any other stakeholder.

The system 100 also includes one or more architect systems 122. In some implementations, the system 122 is used by one or more persons who are assigned to be the systems architect(s) for the particular application being developed. For example, such a role can entail defining and managing the overall structure of the software and/or hardware that will form part of the system. The system 122 includes the collaboration tool 116 to allow the architect to give input on the work of the developer, and/or to receive feedback on an architecture from the developer or any other stakeholder.

The system 100 also includes one or more product owner systems 124. In some implementations, the product owner can be a manager or other supervisor within a company who has been assigned responsibility for the particular product that is being designed and/or manufactured. For example, if the developer has been asked to write an application program that is to be included in a business suite of applications that the company makes, then the product owner for the business suite may be considered the relevant product owner for the application program. The system 124 includes the collaboration tool 116 to allow the product owner to give input on the work of the developer, and/or to receive feedback on the product as a whole from the developer or any other stakeholder.

The system 100 also includes one or more end user systems 124. The end user is the person who is intended to be using the application program and/or the finished product once it is ready. In some implementations, the end user can be involved in the collaboration while the application is being designed and/or developed. For example, during the design/development process the developer can expose the application and/or some related work product to one or more end users via the collaboration tool 116. The end user(s) can give their feedback, make edit suggestions, and/or upload helpful documents, using the collaboration tool implemented in the end user system(s) 126.

The system 100 includes at least one backend server system 126 that can control or otherwise manage the collaboration between two or more components in the system. The backend server system includes an exposure component 128 that coordinates how the various systems can talk to each other. Particularly, the exposure component exposes the relevant information to each respective user. In some implementations, the exposure component stores data 130 regarding the various projects and collaborations thereon. For example, the data 130 includes information about the projects that have been exposed for collaboration.

In some implementations, the exposure component 128 stores relations 132 regarding the collaboration personas. For example, the relations 132 can specify that a particular project is open for collaboration by UI designers, architects and end users.

In some implementations, the exposure component 128 stores models 134 regarding who participates in collaboration. Participation can be conditioned on explicit permission, on user role, on user rating (to be described below), to name just a few examples.

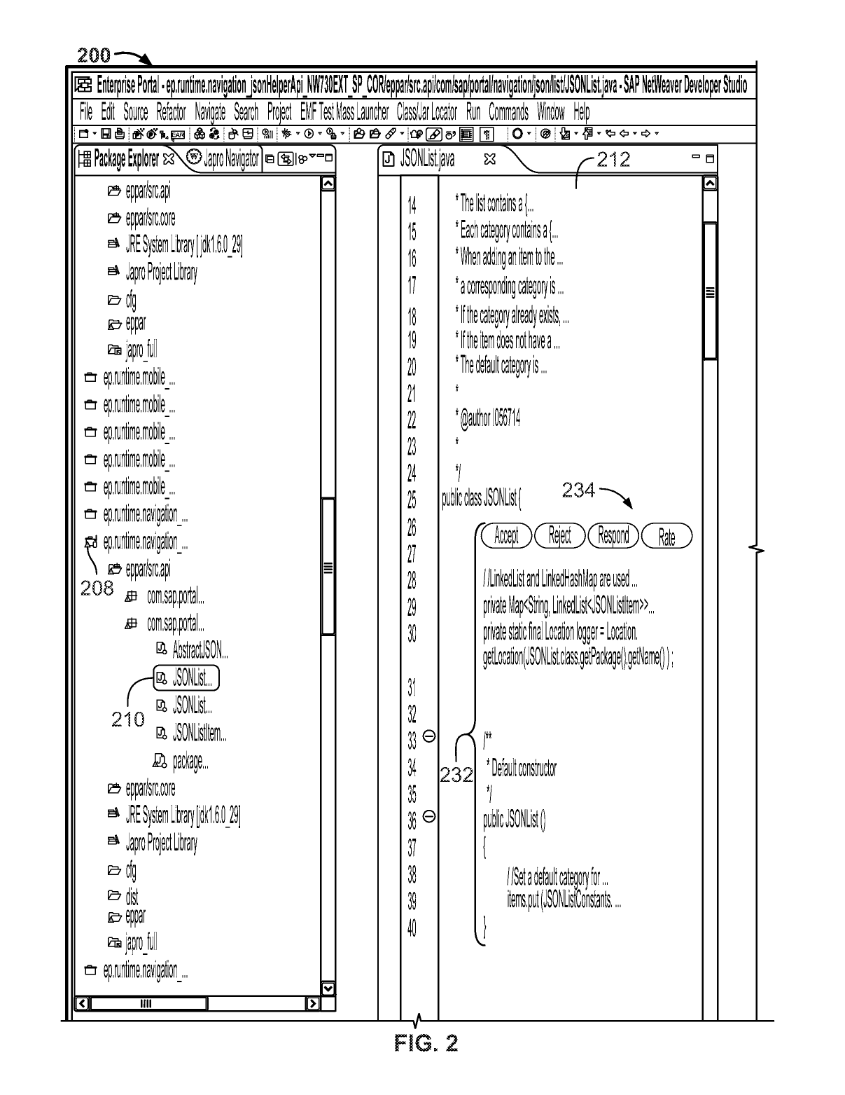

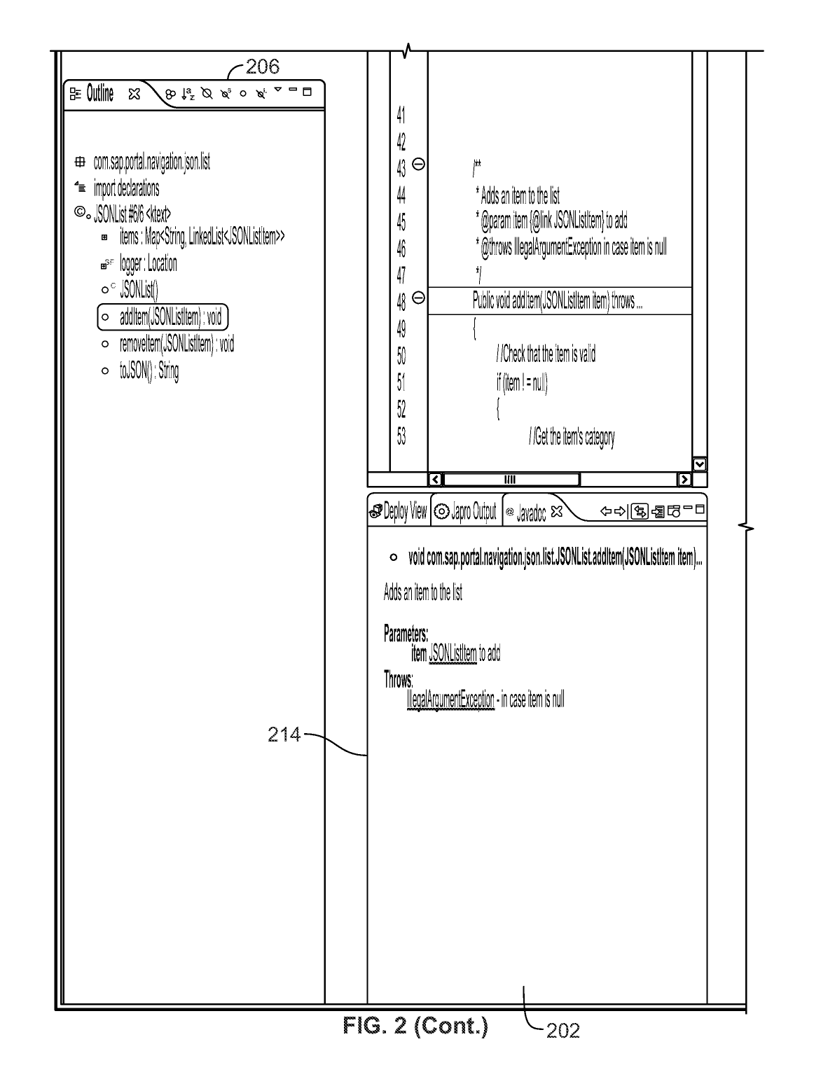

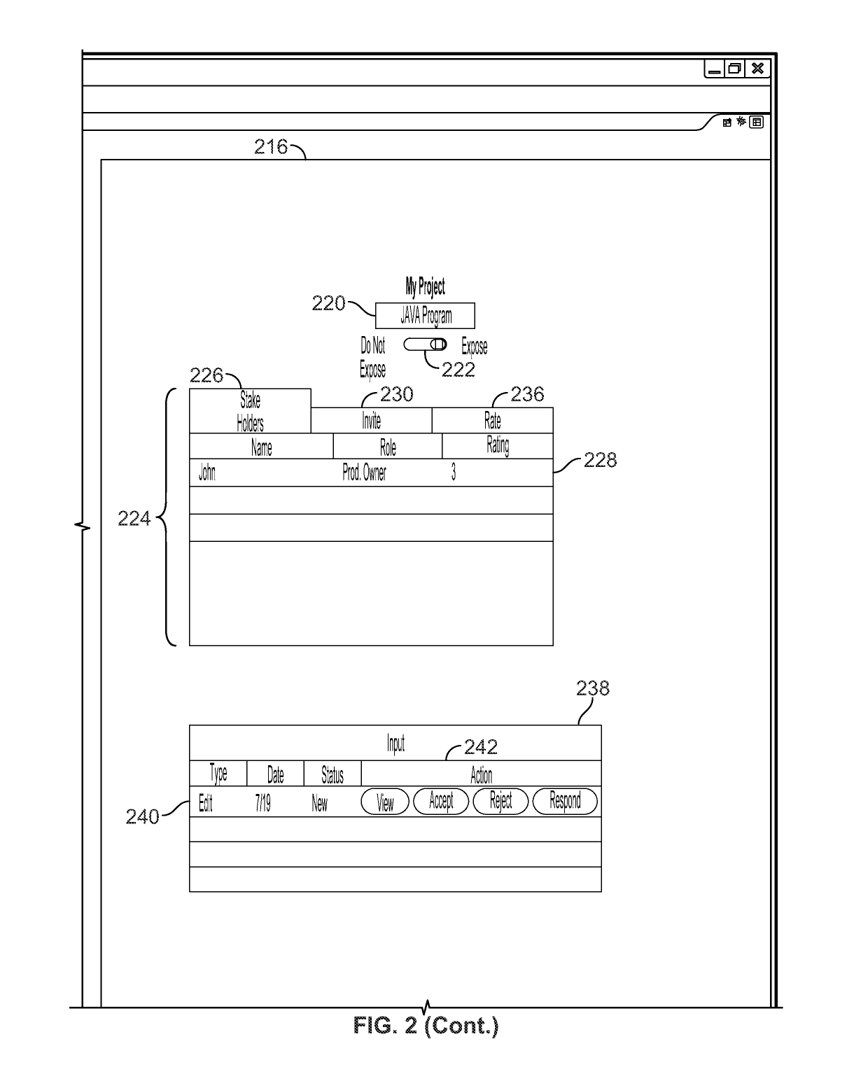

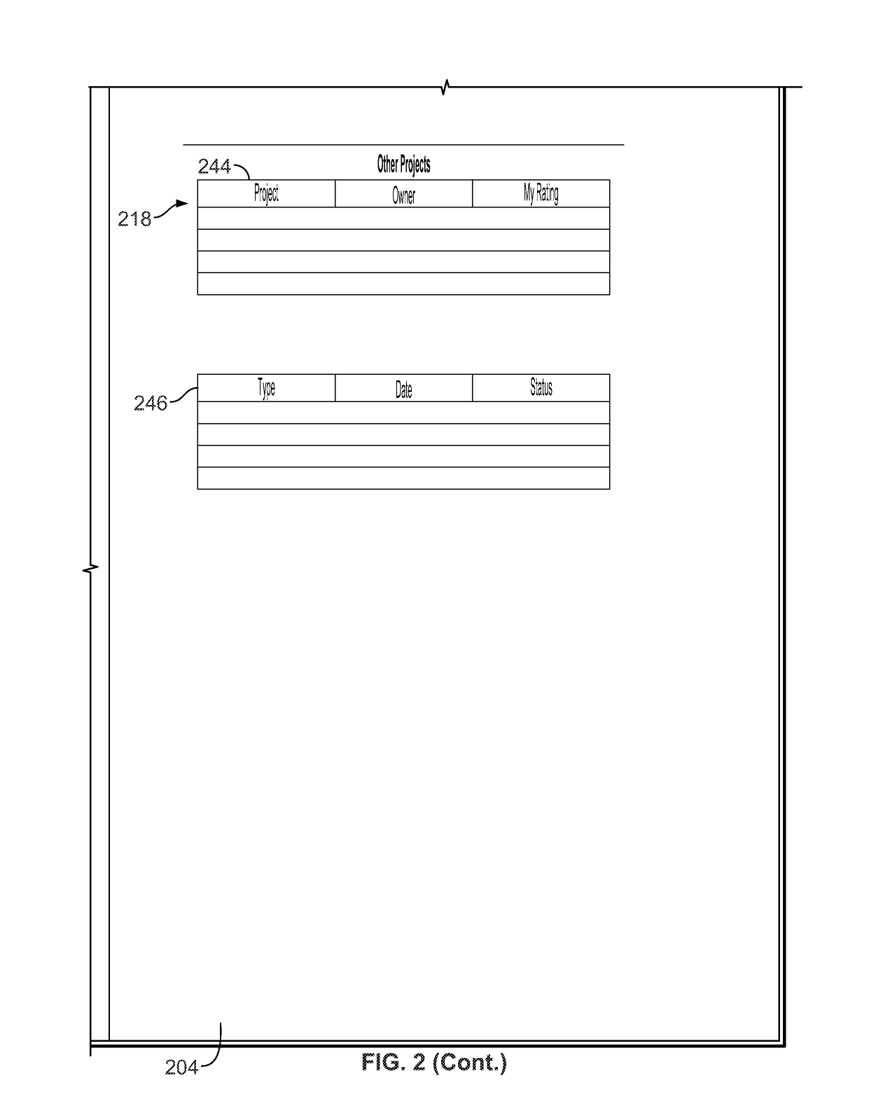

FIGS. 2-5 show examples of integrated development environments (IDEs) that facilitate a social process of application development. FIG. 2 shows an IDE 200 that comprises an IDE area 202 and a collaboration management area 204. In this example, the IDE area 202 contains some content that is available in the NetWeaver Developer Studio available from SAP AG. In some implementations, the IDE area 202 can also or instead contain content from one or more other IDEs.

Here, the IDE area 202 includes a package explorer area 206. In some implementations, the area 206 can be used to browse, choose between, and/or otherwise manage the packages that are available to the developer in the IDE. For example, the developer has here chosen a package 208 that relates to helper application programming interfaces (APIs) in JavaScript object notation (JSON). Particularly, the developer has opened a list 210 in that package and a work area 212 currently shows some of the content from the list 210. An additional area 214 currently shows a documentation generator (e.g., Javadoc) that can be used with the code being developed.

The collaboration area 204 currently includes a my project area 216 and an other projects area 218. The my project area 216 allows the developer to control and benefit from the collaboration on his or her current development project. A name field 220 indicates that the current project is named “JAVA program.” By typing or otherwise entering (e.g., by a browse function) a different project name in the field 220, the developer can instead access another one of his or her projects in a corresponding way.

An expose control 222 provides the developer overall control whether to expose the project for collaboration with one or more other people. For example, the control 222 here has alternative settings of “do not expose” and “expose,” respectively. Currently, the JAVA program project is being exposed for collaboration.

A stakeholders area 224 in the my project area 216 informs the developer who the stakeholders are for this project. That is, a stakeholders tab 226 is currently selected and can present an entry 228 for each stakeholder. The listed stakeholder(s) have access to the project materials when the expose control 222 is set to expose the project. In some implementations, this is facilitated by the backend server system 126 (FIG. 1.) In the current example, the stakeholder is named John and is a product owner relating to this development. The product owner has a rating of three, which will be described below.

The developer can activate an invite tab 230 to invite one or more other stakeholders to participate in the collaboration. For example, an end user can be contacted and asked to collaborate. If so, the new stakeholder's name or other identity will be listed as another one of the entry 228.

The stakeholder John has made a suggested edit in the list that the developer is currently looking at. In the work area 212, a bracket 232 indicates what writing John has added. That is, the edited language is tracked and can be indicated in any suitable way, such as by coloring, underlining, offsetting, and/or by the bracket 232.

The work area 212 also includes controls 234 regarding John's edit. In some implementations, the control(s) provide the developer a way of taking one or more actions regarding the stakeholder's input. For example, the developer can here choose to accept, reject, or respond to, the proposed change, and if so the appropriate action(s) will be performed. In some implementations, such input(s) can be communicated to the backend server system 126 (FIG. 1) for performing the appropriate action(s).

The controls 234 also provide the developer an opportunity to enter or modify a rating for the stakeholder, by a “Rate” control. That is, the system generating the IDE 200 can keep track of a rating for some or all of the stakeholders on each project, and the rating(s) can then be used for one or more purposes. The Rate control 234 allows the developer to give input to affect the stakeholder's rating. For example, the developer can specify the rating that the stakeholder should have (e.g., a number between one and five.) As another example, the developer can adjust a current rating for the stakeholder upward or downward using plus and minus buttons. The stakeholder area 224 here includes a rate tab 236 that the developer can use to specify or adjust the rating for the stakeholder. For example, a new or updated rating can be communicated to the backend server system 126 (FIG. 1.)

Ratings can be affected by other actions. In some implementations, if the developer accepts a proposed change (such as the one by the product owner in this example), that can prompt a positive rating for the stakeholder who made the input. On the contrary, if the developer does not accept, or explicitly rejects, the proposed change, this can lead to a negative rating. For example, a current rating can be adjusted upward or downward.

Here, the stakeholder area 224 shows that the product owner John currently has a rating of three with regard to this particular project. In some implementations, the current rating can then be adjusted up or down depending on whether the developer accepts or rejects the proposed change. A stakeholder's rating can decide whether, or how prominently, a future input from the stakeholder is brought to the developer's attention. For example, when a stakeholder for whom the developer has accepted eight out of ten suggestions makes a new input, this new suggestion may be presented to the developer at the top of the list. On the contrary, with a stakeholder for whom the developer has accepted only one out of twelve inputs, an additional suggestion may be presented to the developer at the bottom of the list, or not at all. In some implementations, ratings are managed, and/or acted upon, by the backend server system 126 (FIG. 1)

If the developer selects any of the entries 228 in the stakeholder area 224, an input area 238 can show the received inputs that this particular stakeholder has provided. In some implementations, the suggestion indicated by the bracket 232 can be represented by an entry 240. For example, the entry can indicate what type of input was received (e.g., a code edit, a comment, a UI design suggestion, or a document upload), when it was received (here, on July 19), and the status of the input (e.g., whether it is new or if the developer has previously considered the input). An action bar 242 can provide the developer the opportunity to take one or more actions regarding the input corresponding to the entry 240. The developer can view the input (e.g., the bracket 232 and the controls 234 can appear in the work area 212), accept or reject the input, or respond to the stakeholder from whom the input was received.

The other projects area 218 includes a project area 244 that can show entries for one or more other projects where this developer is a stakeholder. In some implementations, each entry can state the project's name, the name of the project owner, and the rating (if any) that the current developer has as a stakeholder on that project. For example, clicking on the project can give the developer access to that other project (e.g., by an update of the IDE area 202.)

The other projects area 218 can also include an input area 246 associated with the project that is currently in focus (e.g., the selected entry) in the project area 244. In some implementations, if the developer selects any project in the area 244 then the input area 246 can show the input(s), if any, that the developer has previously made for that project. For example, each input can be described in terms of the type of input, when it was made, and its current status.

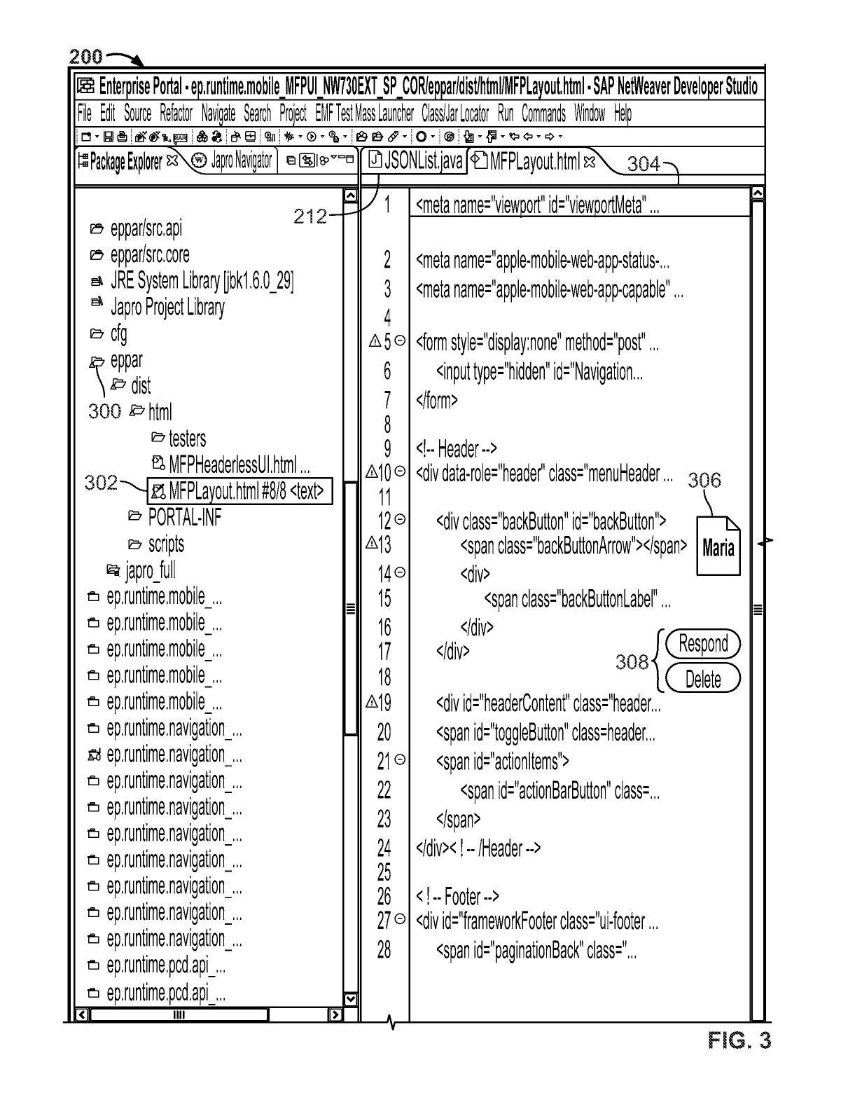

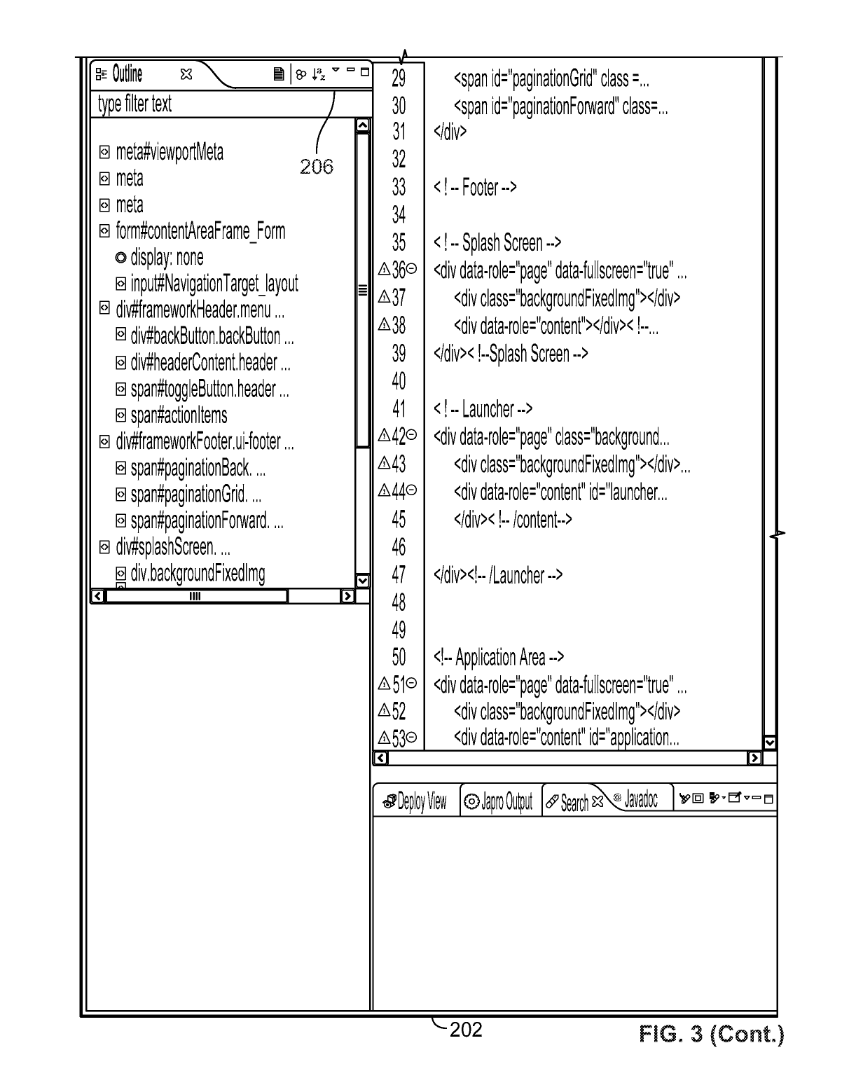

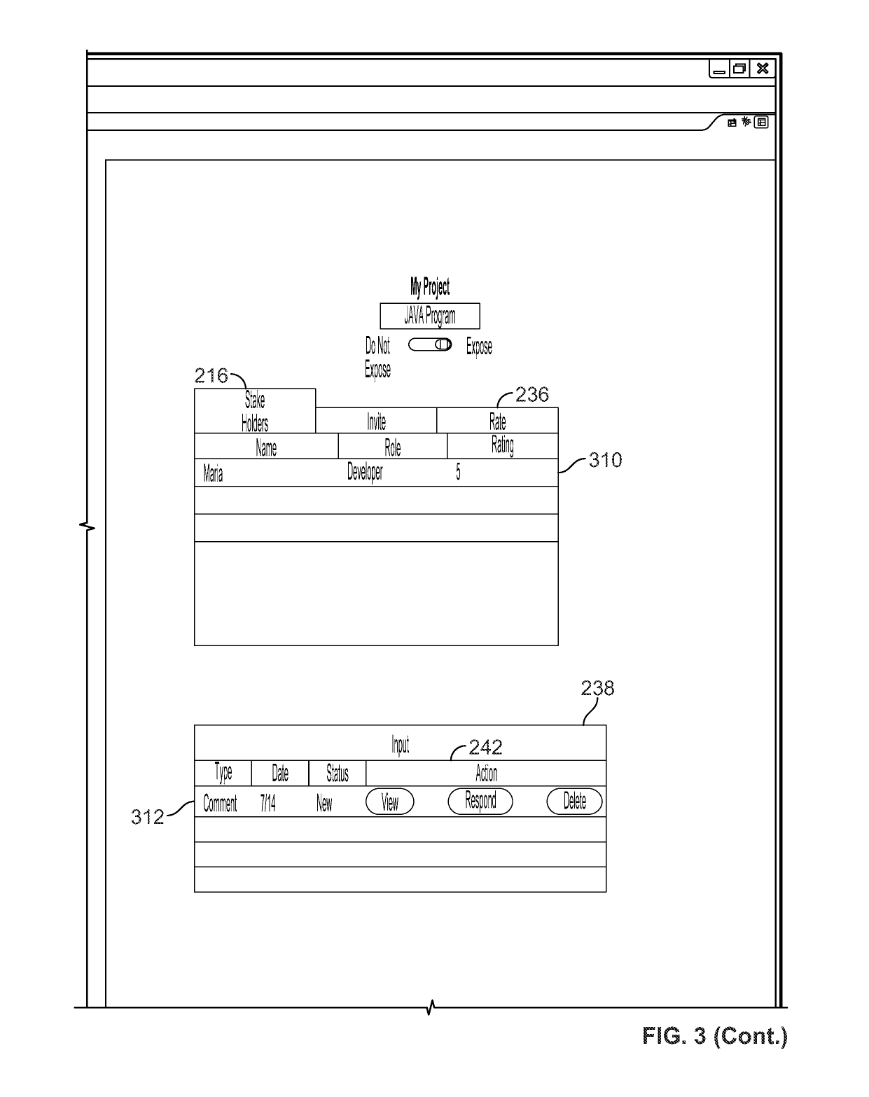

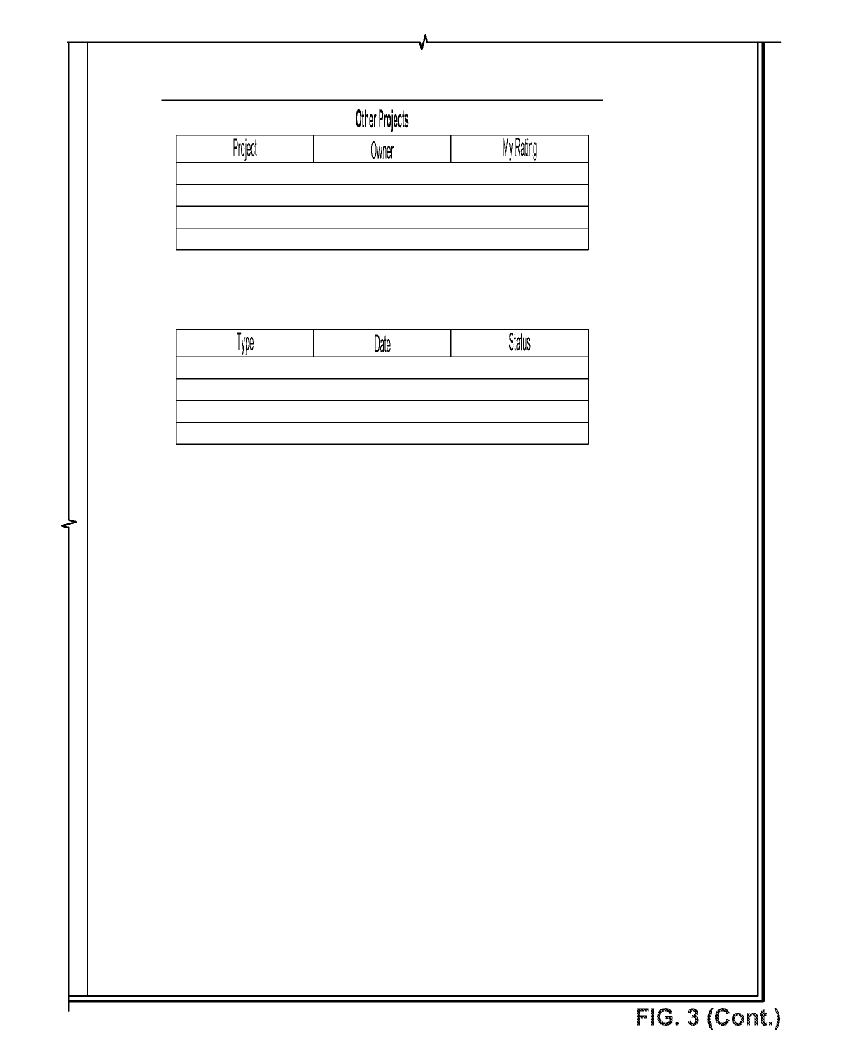

FIG. 3 shows the IDE 200 when the developer has made another selection in the package explorer area 206. Particularly, the developer has selected a folder 300 labeled “eppar” and in there has opened a hypertext markup language (html) document 302 labeled MFPLayout.html. This has caused a new work area 304 to appear in the IDE area 202. The work area 212 that was described above is available as a tab.

Here, the work area 304 shows that a comment 306 has been attached by a stakeholder. In this example, the comment is labeled with the stakeholder's name

“Maria.” The comment can be accessed in any suitable way, such as by clicking on it. Controls 308 adjacent the comment 306 allow the developer to respond to the comment and/or delete it.

The stakeholder area 216 now includes an entry 310 showing that the stakeholder Maria is a developer and that she has a rating of five in the current project. Also, because Maria is the stakeholder currently in focus, the input area 238 now shows that Maria's input is of the type comment, that it was made on July 14, and that its status remains new. The actions bar 242 allows the developer to view Maria's comment, respond to it and/or delete it. The rate tab 236 allows the developer to specify or adjust Maria's rating.

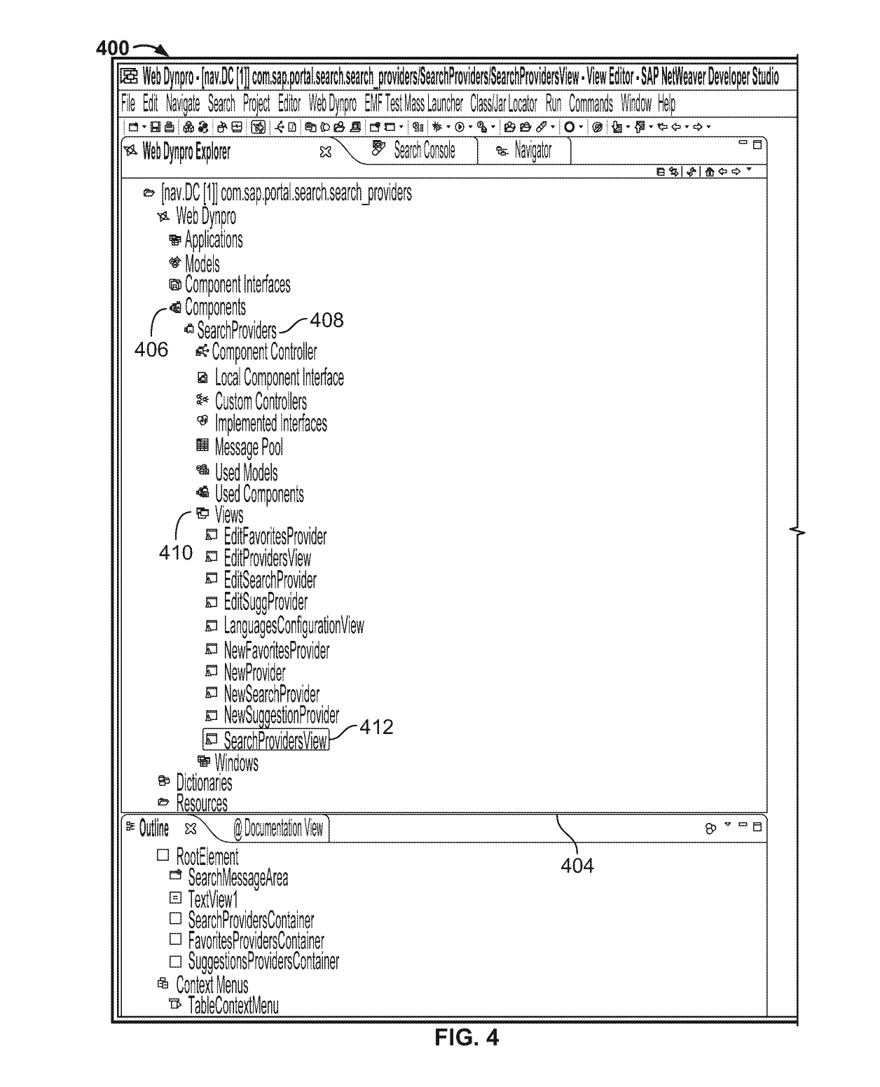

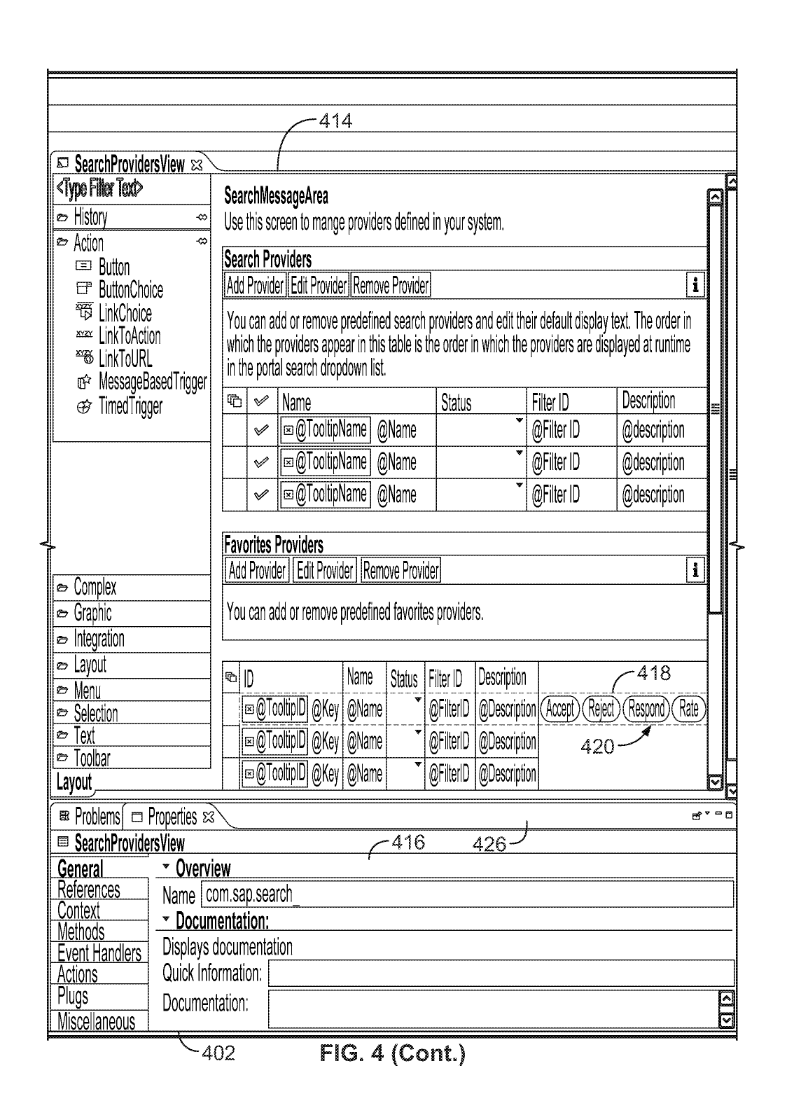

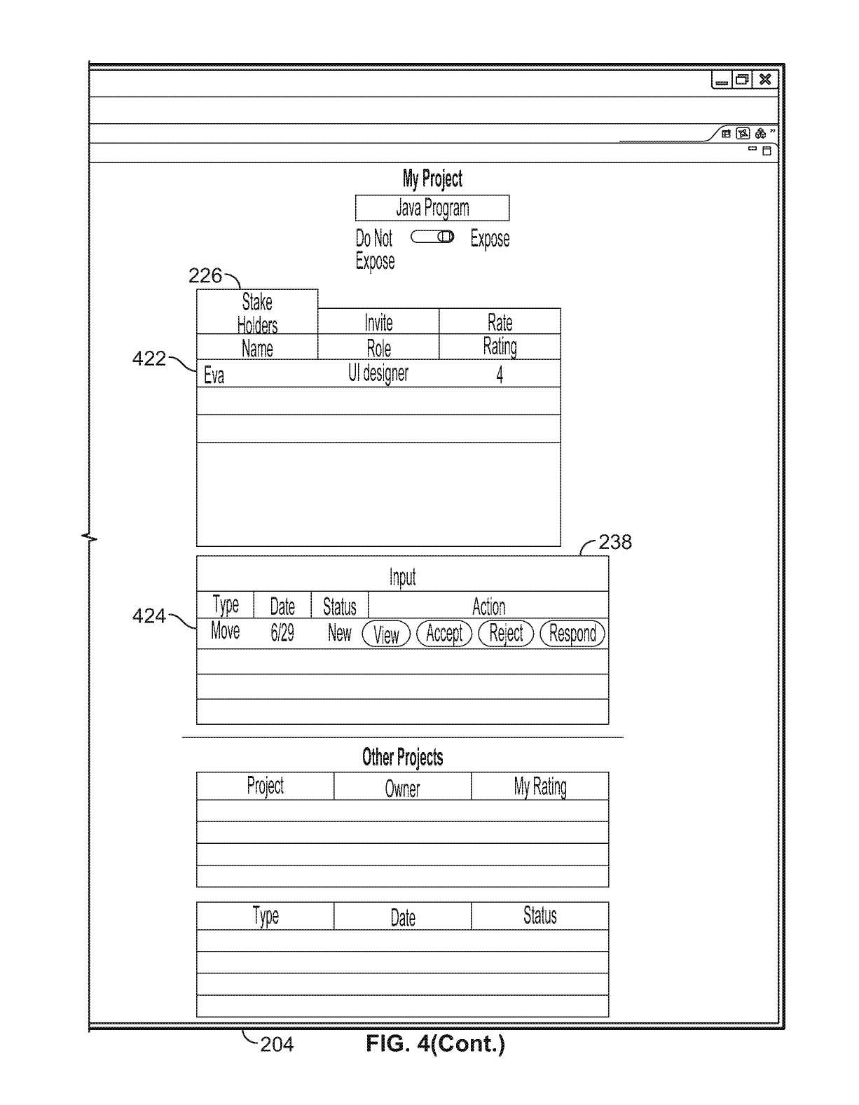

FIG. 4 shows an IDE 400 that is being used to work on a UI. The IDE 400 includes an IDE area 402 and the collaboration area 204. In this example, the IDE work involves the Web Dynpro technology from SAP AG, and the IDE area 402 therefore includes a Web Dynpro explorer area 404. Particularly, in the explorer area the developer has selected a components group 406, and within that a search providers collection 408. In the search providers collection, moreover, the developer has chosen a views option 410 and among the views has chosen to work on a search providers view 412. A work area 414 in the IDE area 402 is therefore updated with content regarding the search providers view. An additional area 416 currently presents properties regarding the search providers view.

In the work area 414, a highlight 418 indicates a proposed change that has been suggested by a stakeholder. Any suitable form of highlighting can be used, such as a border or a different color, to name just a few examples. Here, the suggestion is a move of some UI element (in this example, a favorite search provider), and the developer can use controls 420 to accept or reject the suggestion, respond to the stakeholder, and/or rate the stakeholder.

The stakeholder tab 226 indicates by an entry 422 that the stakeholder's name is Eva, and that she is a UI designer who currently has a rating of four with the present project. The input area 238 indicates by an entry 424 that Eva's input is a suggested move (in this example, of a UI element), that it was made on June 29 and that its status is still new.

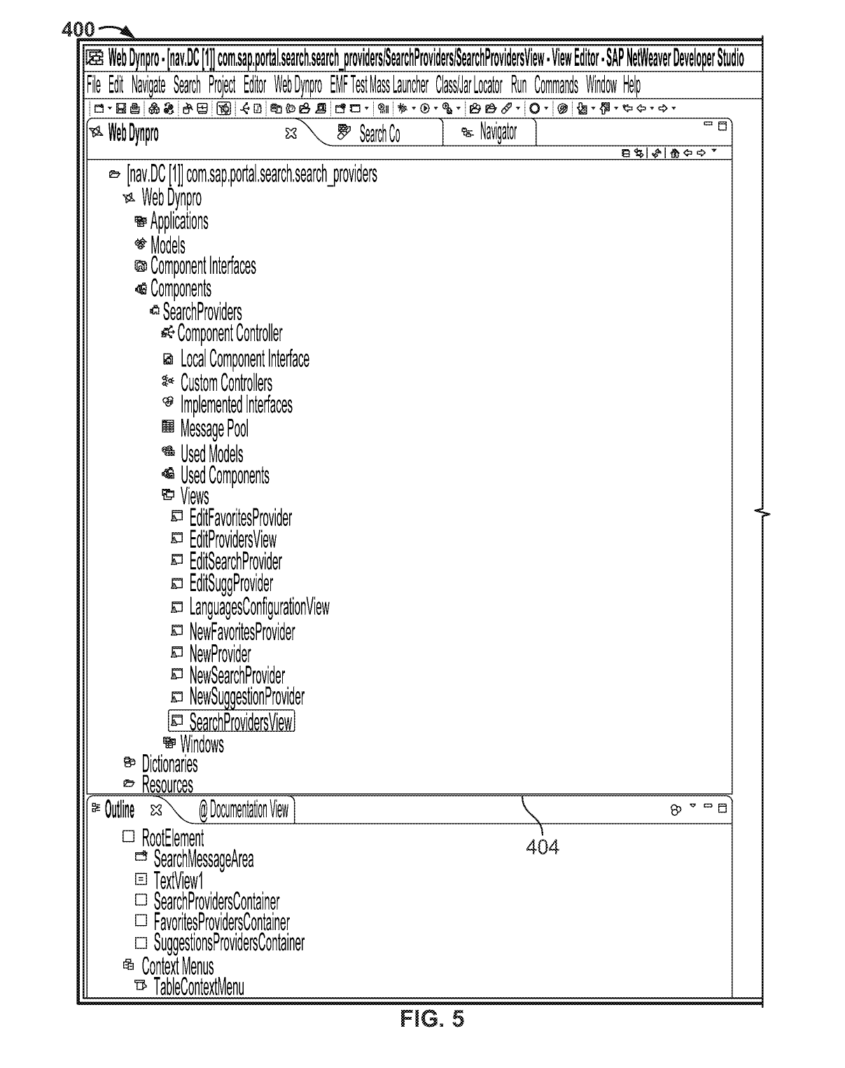

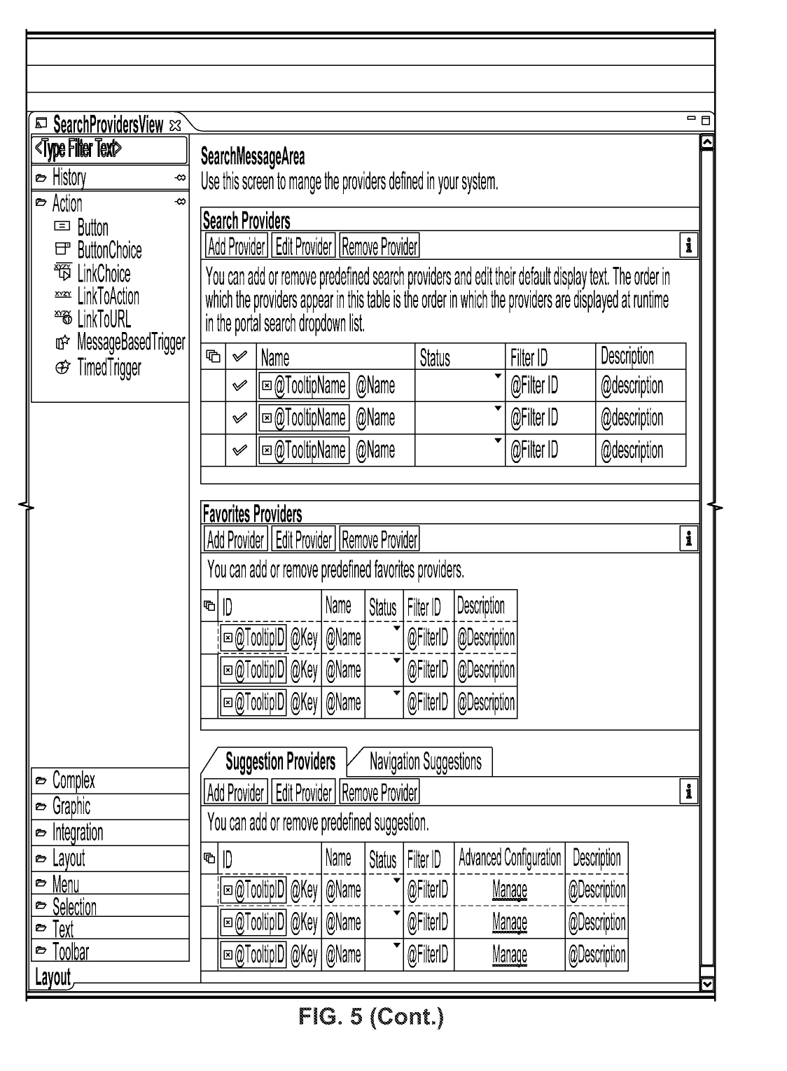

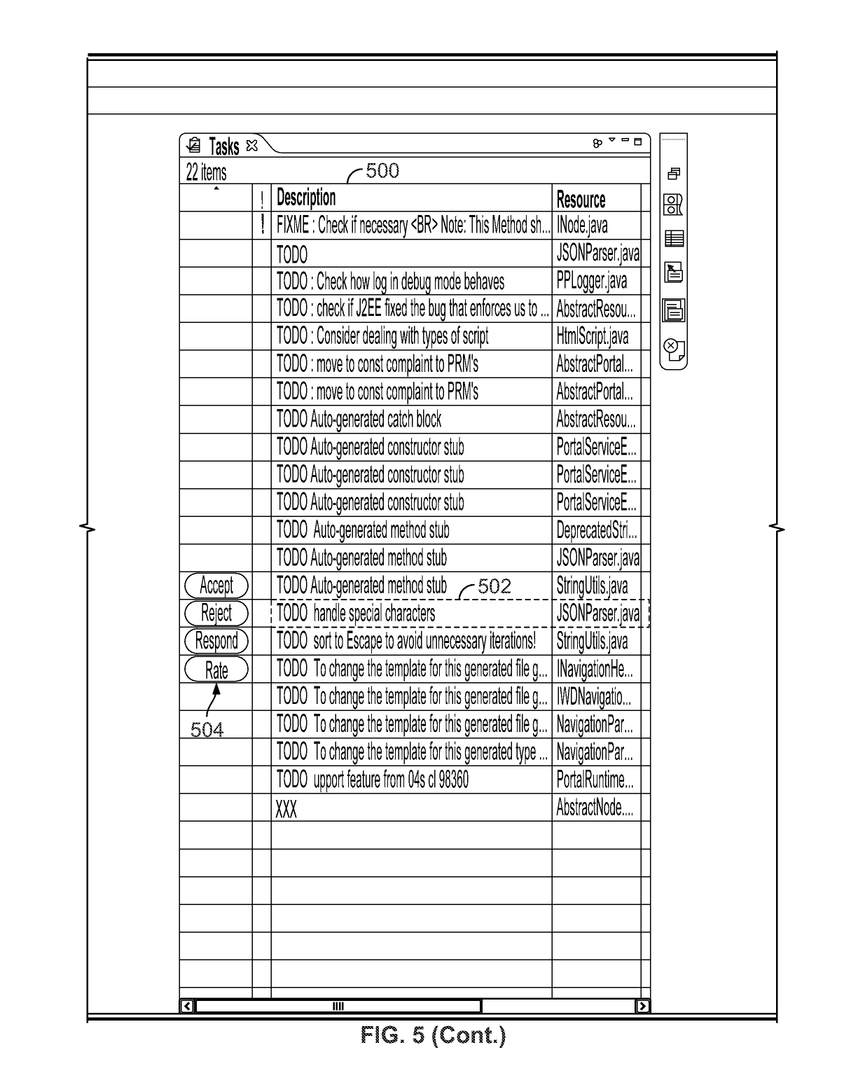

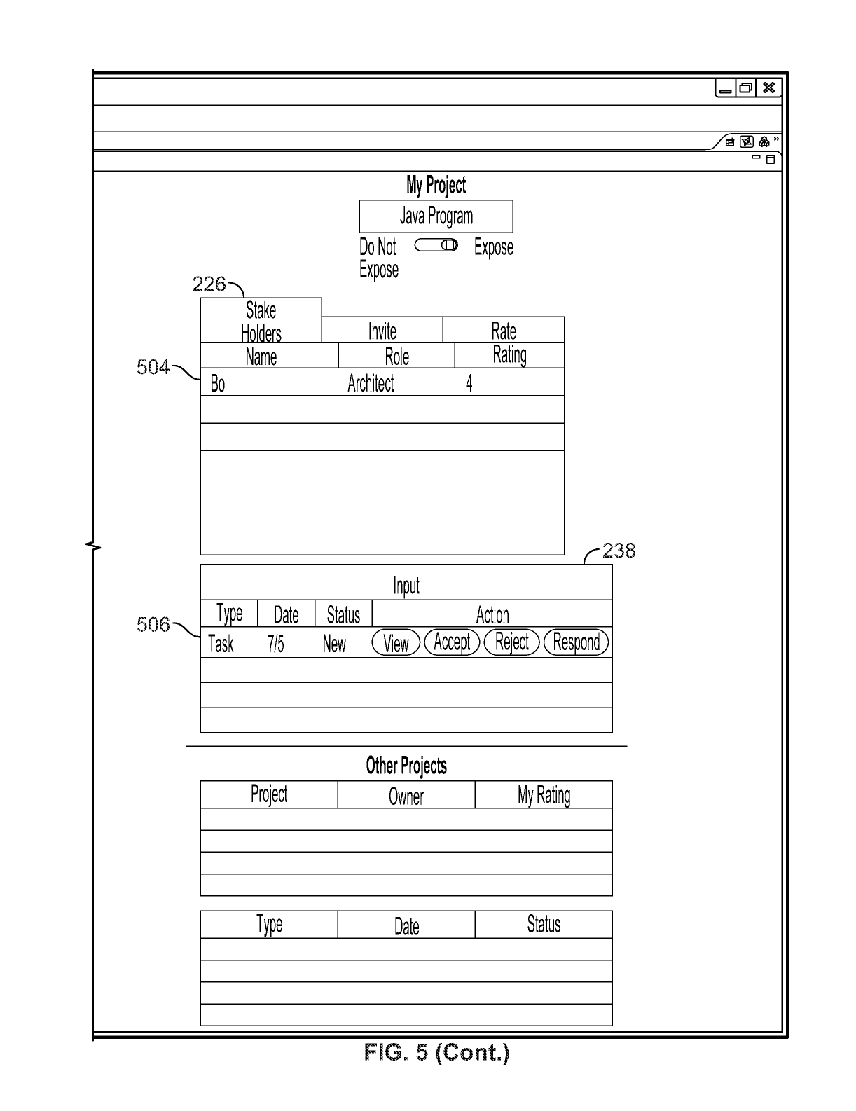

To view one or more tasks that are pending or proposed for the current project, the developer can select a tasks tab 426. FIG. 5 shows the IDE 400 after such a selection, where a tasks area 500 has also been included. The tasks in the area 500 may have been created by the developer, by a manager or supervisor, and/or by the product owner, to name a few examples. Any task(s) received from stakeholders by collaborative input can be highlighted accordingly. Here, a task 502 has been proposed by another person and is therefore enclosed with a border (any suitable highlighting technique can be used.) For example, the task 502 suggests as a to-do task that the developer should ensure handling of special characters. Controls 504 can be used to accept or reject the suggestion, respond to the stakeholder, and/or rate the stakeholder. Here, the stakeholder tab 226 indicates by an entry 504 that the stakeholder's name is Bo, and that he is an architect who currently has a rating of four with the present project. The input area 238, moreover, indicates by an entry 506 that Bo's input is a suggested task that was made on June 29 and whose status is still new.

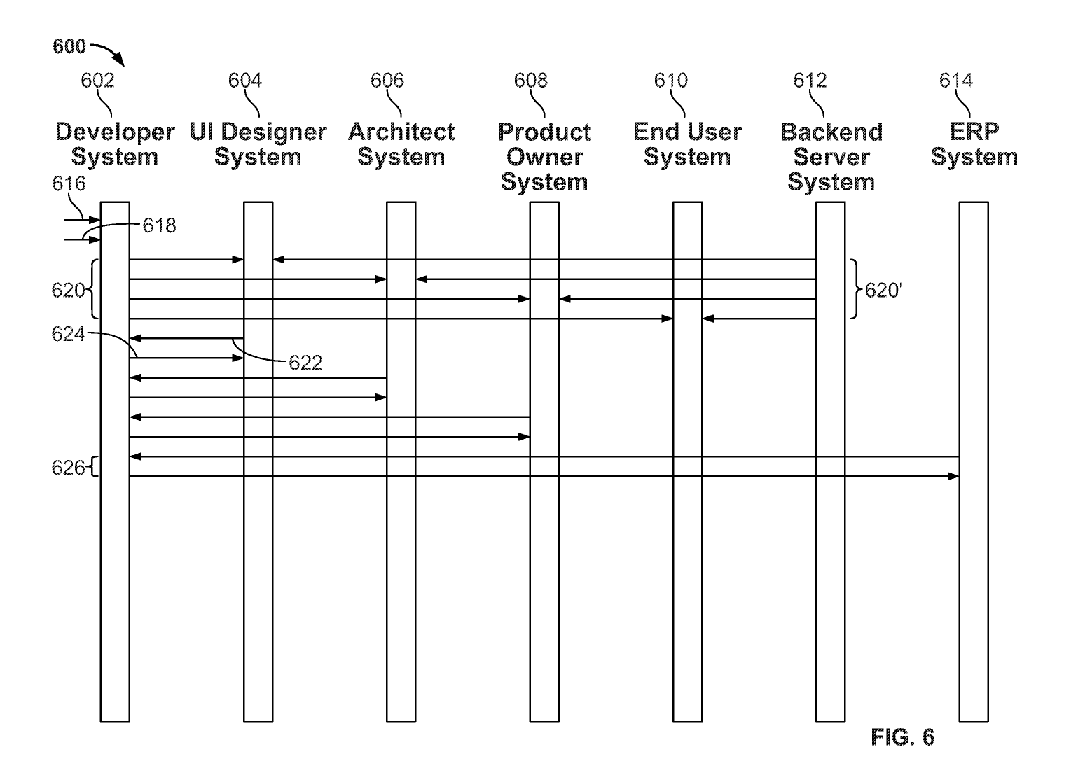

FIG. 6 shows an example of a flow diagram for a social process 600 of application development. The social process 600 involves systems 602-10 for a developer, UI designer, architect, product owner, and end user, respectively. The process also involves a backend server system 612 and an ERP system 614. For example, these systems can correspond to those described above with reference to FIG. 1, and/or to those in the examples of FIGS. 2-5.

At 616, the developer defines a project in the developer system and decides to expose the project for collaboration. For example, the JAVA program project described above can be defined. At 618, the developer enters material in the project (e.g., writes code or defines a UI layout.) Because the project is open for collaboration, the material is made available to the other systems, as indicated by arrows 620, for the stakeholder(s) to make suggestions. In implementations that use the backend server system 612, the developer system 602 can instead make these communications to the backend server, and the backend server can then provide the appropriate information to some or all of the systems 602-10, as schematically indicated by arrows 620′.

The developer system 602 can receive a message 622 generated from any of the other systems, the message including some stakeholder's input on some aspect of the project. The developer can generate one or more messages 624 in return. For example, the message 624 can include a response to the input and/or an update about the stakeholder's rating with regard to the current project. In some implementations, when the project is complete (e.g., after the developer considers all inputs and finishes the work), suitable programming code can be provided to the ERP system, as indicated by arrows 626.

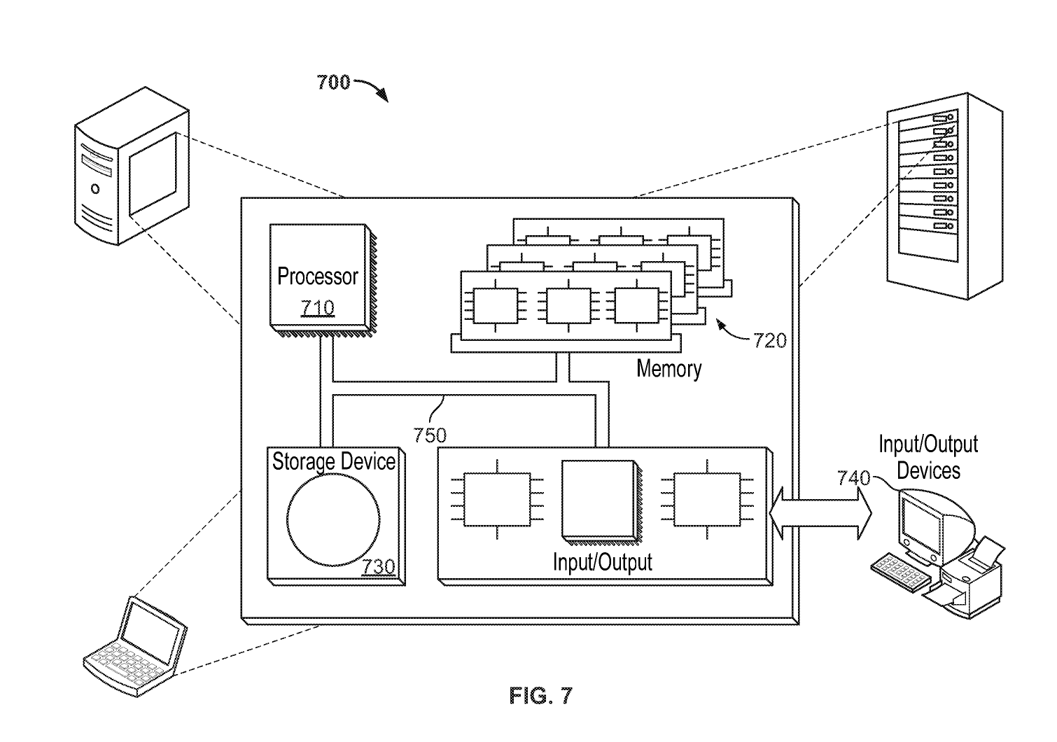

FIG. 7 is a schematic diagram of a generic computer system 700. The system 700 can be used for the operations described in association with any of the computer-implement methods described previously, according to one implementation. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. The memory 720 is a volatile memory unit in some implementations and is a non-volatile memory unit in other implementations.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for managing a social process of developing an application, the method comprising:
making an integrated development environment accessible to a user;
exposing a work product of the user in the integrated development environment to a selected group of users;
receiving, in the integrated development environment, a first input regarding the work product from at least one of the selected group of users; and
presenting the first input to the user in the integrated development environment.

2. The computer-implemented method of claim 1, wherein receiving the input comprises receiving a document uploaded by the at least one of the selected group of users, and wherein presenting the input to the user comprises providing the user access to the uploaded document.

3. The computer-implemented method of claim 1, wherein exposing the work product comprises sharing material from the user, wherein receiving the input comprises receiving a change to the material from the at least one of the selected group of users, and wherein presenting the input to the user comprises tracking the change in the material.

4. The computer-implemented method of claim 3, wherein presenting the input to the user further comprises providing the user ability to accept or reject the tracked change.

5. The computer-implemented method of claim 1, wherein presenting the first input to the user further comprises providing the user ability to make a second input in the integrated development environment, the second input indicating at least whether the user accepts or rejects the first input.

6. The computer-implemented method of claim 5, further comprising assigning a rating to the at least one of the selected group of users based on whether the user accepts or rejects the first input.

7. The computer-implemented method of claim 6, further comprising performing at least one action in the integrated development environment regarding the at least one of the selected group of users, the action selected based on the assigned rating.

8. A computer program product embodied in a non-transitory computer-readable storage medium and comprising instructions that when executed by a processor perform a method for managing a social process of developing an application, the method comprising:
making an integrated development environment accessible to a user;
exposing a work product of the user in the integrated development environment to a selected group of users;
receiving, in the integrated development environment, a first input regarding the work product from at least one of the selected group of users; and
presenting the first input to the user in the integrated development environment.

9. The computer program product of claim 8, wherein receiving the input comprises receiving a document uploaded by the at least one of the selected group of users, and wherein presenting the input to the user comprises providing the user access to the uploaded document.

10. The computer program product of claim 8, wherein exposing the work product comprises sharing material from the user, wherein receiving the input comprises receiving a change to the material from the at least one of the selected group of users, and wherein presenting the input to the user comprises tracking the change in the material.

11. The computer program product of claim 10, wherein presenting the input to the user further comprises providing the user ability to accept or reject the tracked change.

12. The computer program product of claim 8, wherein presenting the first input to the user further comprises providing the user ability to make a second input in the integrated development environment, the second input indicating at least whether the user accepts or rejects the first input.

13. The computer program product of claim 12, the method further comprising assigning a rating to the at least one of the selected group of users based on whether the user accepts or rejects the first input.

14. The computer program product of claim 13, the method further comprising performing at least one action in the integrated development environment regarding the at least one of the selected group of users, the action selected based on the assigned rating.

15. A system comprising:
one or more processors; and
a computer program product embodied in a non-transitory computer-readable storage medium and comprising instructions that when executed cause performance of a method for managing a social process of developing an application, the method comprising:
making an integrated development environment accessible to a user;
exposing a work product of the user in the integrated development environment to a selected group of users;
receiving, in the integrated development environment, a first input regarding the work product from at least one of the selected group of users; and
presenting the first input to the user in the integrated development environment.

16. The system of claim 15, wherein receiving the input comprises receiving a document uploaded by the at least one of the selected group of users, and wherein presenting the input to the user comprises providing the user access to the uploaded document.

17. The system of claim 15, wherein exposing the work product comprises sharing material from the user, wherein receiving the input comprises receiving a change to the material from the at least one of the selected group of users, and wherein presenting the input to the user comprises tracking the change in the material.

18. The system of claim 17, wherein presenting the input to the user further comprises providing the user ability to accept or reject the tracked change.

19. The system of claim 15, wherein presenting the first input to the user further comprises providing the user ability to make a second input in the integrated development environment, the second input indicating at least whether the user accepts or rejects the first input.

20. The system of claim 19, the method further comprising assigning a rating to the at least one of the selected group of users based on whether the user accepts or rejects the first input, and performing at least one action in the integrated development environment regarding the at least one of the selected group of users, the action selected based on the assigned rating.
